(19) United States
(12) Patent Application Publication
(10) Pub. No.: US 2024/0282493 A1
(43) Pub. Date: Aug. 22, 2024

(54) INTEGRALLY-MOLDED COIL AND POWER CONVERSION DEVICE

(71) Applicant: Panasonic Intellectual Property Management Co., Ltd., Osaka (JP)

(72) Inventors: Atsushi YAMASHIMA, Kanagawa (JP); Akitaka YOSHIKAWA, Kanagawa (JP)

(21) Appl. No.: 18/424,416

(22) Filed: Jan. 26, 2024

(30) Foreign Application Priority Data
Feb. 22, 2023 (JP) 2023-026484

(51) Int. Cl. H01F 5/06; H01F 5/00; H01F 5/04; H01F 27/28; H02M 3/00; H02M 7/00

(52) U.S. Cl. CPC H01F 5/06; H01F 5/003; H01F 5/04; H01F 27/2876; H02M 3/003; H02M 7/003

(57) ABSTRACT

An integrally-molded coil according to the present disclosure includes a coil portion and a resin portion. The resin portion is formed by molding a resin material having electrical insulation and thermal conductivity using the coil portion as an insert. The coil portion includes a coil main body and one or more pairs of leads each extending from the coil main body to an outside of the resin portion. An outer surface of the resin portion is applied with a surface treatment for imparting electrical conductivity, and is insulated from the one or more pairs of leads.

### CROSS-REFERENCE TO RELATED APPLICATIONS

This application is based upon and claims the benefit of priority from Japanese Patent Application No. 2023-026484, filed on Feb. 22, 2023, the entire contents of which are incorporated herein by reference.

### FIELD

Embodiments described herein relate generally to an integrally-molded coil and a power conversion device.

### BACKGROUND

Conventionally, a power conversion device using a filter coil such as a toroidal coil for reducing high-frequency noise has been known as a charger mounted on an electric vehicle or the like. The filter coil generates a large amount of heat and generates radiation noise. For this reason, the power conversion device requires a technique for realizing cooling and electromagnetic shielding. Conventional technologies are described in Japanese Patent Application Laid-open No. 2020-123656, for example.

However, it is necessary to separately provide a heat dissipation structure and an electromagnetic wave shielding structure, such as forming a heat dissipation structure by potting a coil or forming an electromagnetic wave shielding structure by using a die-cast or sheet-metal casing, and it is difficult to downsize the device.

### SUMMARY

An integrally-molded coil according to an embodiment of the present disclosure includes a coil portion and a resin portion formed by molding a resin material having electrical insulation and thermal conductivity using the coil portion as an insert. The coil portion includes a coil main body and one or more pairs of leads each extending from the coil main body to an outside of the resin portion, and an outer surface of the resin portion is applied with a surface treatment for imparting electrical conductivity, and is insulated from the one or more pairs of leads.

### BRIEF DESCRIPTION OF THE DRAWINGS

FIG. 1 is a schematic perspective view illustrating an example of a configuration of a power conversion device according to a first embodiment;

FIG. 2 is a plan view illustrating a schematic configuration of an integrally-molded coil in FIG. 1;

FIG. 3 is a front view illustrating the schematic configuration of the integrally-molded coil in FIG. 1;

FIG. 4 is a bottom view illustrating the schematic configuration of the integrally-molded coil in FIG. 1;

FIG. 5 is a schematic perspective view illustrating an example of a configuration of a power conversion device according to a second embodiment;

FIG. 6 is a front view illustrating a schematic configuration of an integrally-molded coil in FIG. 5;

FIG. 7 is a schematic perspective view illustrating an example of a configuration of a power conversion device according to a third embodiment;

FIG. 8 is a plan view illustrating a schematic configuration of an integrally-molded coil in FIG. 7;

FIG. 9 is a front view illustrating the schematic configuration of the integrally-molded coil in FIG. 7; and

FIG. 10 is a bottom view illustrating the schematic configuration of the integrally-molded coil in FIG. 7.

### DETAILED DESCRIPTION

Hereinafter, embodiments of an integrally-molded coil and a power conversion device according to the present disclosure will be described with reference to the accompanying drawings.

Note that in the description of the present disclosure, components having the same or substantially the same functions as those described earlier with respect to the previous drawings are denoted by the same reference numerals, and the description thereof may be appropriately omitted. In addition, even in the case of representing the same or substantially the same portion, the dimensions and ratios may be represented differently from each other depending on the drawings. In addition, for example, from the viewpoint of ensuring visibility of the drawings, only main components are denoted by reference numerals in the description of each drawing, and even components having the same or substantially the same functions as those described earlier in the previous drawings may not be denoted by reference numerals. In addition, components having the same or substantially the same functions as those described earlier with respect to the previous drawings may be distinguished by adding a, b, or c to the end of the reference numeral. Alternatively, in a case where a plurality of components having the same or substantially the same function are not distinguished, a, b, or c added to the end of the reference numeral may be omitted to be integrated and described.

As an example, a power conversion device 1 according to an embodiment is an in-vehicle charger that is mounted on an electric vehicle or the like, converts alternating-current power supplied from a power supply such as an external power supply into direct-current power of a predetermined voltage, and outputs the direct-current power after the conversion to a battery such as a lithium-ion battery. The power conversion device 1 according to the embodiment is mounted with at least one circuit board 2 on which a circuit configuration such as a DC/DC converter or an inverter is mounted.

The power conversion device 1 according to the embodiment is formed by, for example, joining a plurality of components such as an electronic component, the circuit board 2, and a board unit using a fitting member such as a connector, a coupler, a screw, or a bolt, or an adhesive. Note that in the power conversion device 1 according to the embodiment, not all the components may be joined, and electrical connection and thermal connection between some components may be realized by contact between the components. In addition, some components to be joined or in contact with each other may be insulated or thermally insulated.

The electronic component according to the embodiment is, for example, a component such as a semiconductor element, a semiconductor module, a magnetic body, a capacitor, or a circuit breaker. The semiconductor module includes, for example, a plurality of semiconductor elements. Here, the magnetic body is a transformer, a transformer-integrated printed circuit board, a transformer, a reactor, or a choke. The circuit breaker is a relay or a fuse.

The circuit board 2 according to the embodiment is, for example, a printed circuit board (PCB). The printed circuit board is, for example, a glass epoxy substrate formed using an aluminum alloy or a copper alloy as a base material.

Note that the circuit board 2 according to the embodiment may be any circuit board of a board unit, that is, a plurality of joined circuit boards.

Note that the circuit board 2 according to the embodiment may be a circuit board included in a component of a magnetic body such as a transformer, a transformer, a reactor, or a choke, that is, a magnetic component. This magnetic component may have a function as a magnetic component, for example, by having a substrate on which a conductor pattern forms a winding, and forming a closed magnetic path by penetrating a magnetic core inside and outside the winding formed on the substrate. That is, an integrally-molded coil 5 as the magnetic component according to the embodiment may have the circuit board 2.

Note that the plurality of components are not limited to the above, and may include terminal components such as a connector and a coupler for electrical connection, a housing and a support member of the power conversion device 1, and a cooling component.

### First Embodiment

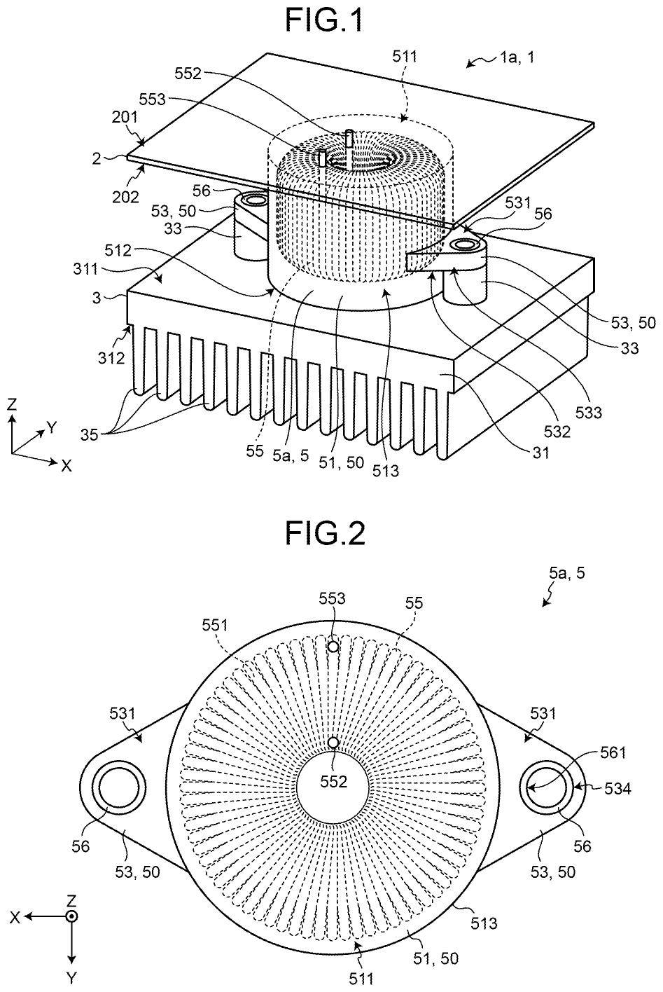

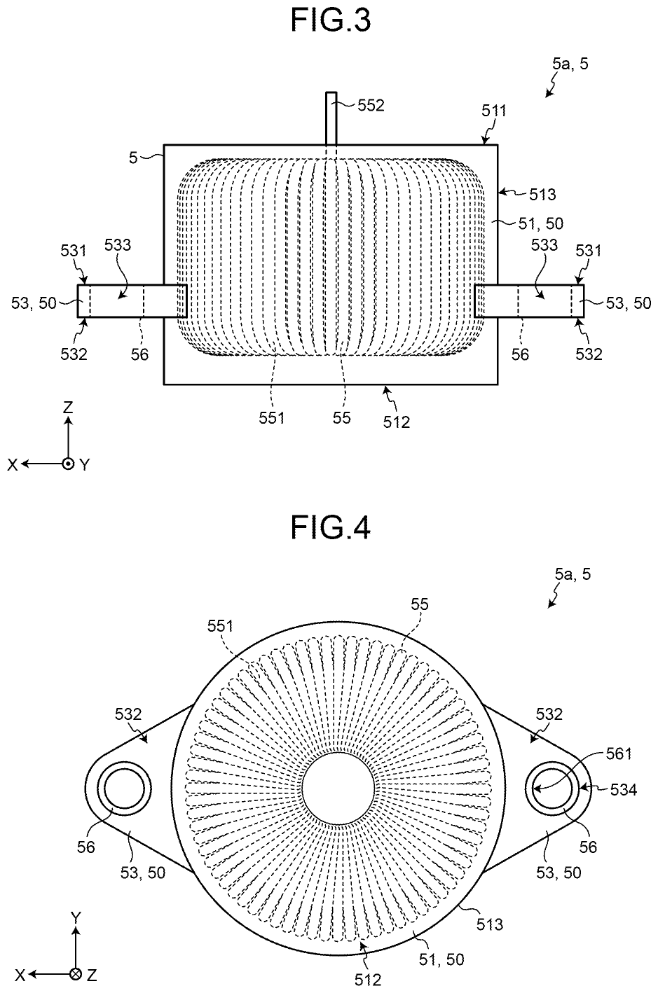

FIG. 1 is a schematic perspective view illustrating an example of a configuration of a power conversion device 1a according to a first embodiment. FIG. 2 is a plan view illustrating a schematic configuration of an integrally-molded coil 5a in FIG. 1. FIG. 3 is a front view illustrating the schematic configuration of the integrally-molded coil 5a in FIG. 1. FIG. 4 is a bottom view illustrating the schematic configuration of the integrally-molded coil 5a in FIG. 1.

As illustrated in FIG. 1, the power conversion device 1a includes the circuit board 2, a cooling member 3, and the integrally-molded coil 5a.

The circuit board 2 supplies power to a coil portion 55 of the integrally-molded coil 5a.

The cooling member 3 is an example of a cooling component of the power conversion device 1a. The cooling member 3 is a component for dissipating heat from the integrally-molded coil 5a. FIG. 1 exemplifies a heat sink as the cooling member 3. The cooling member 3 has electrical conductivity and thermal conductivity. As an example, the cooling member 3 is formed of an aluminum alloy or a copper alloy. As an example, the cooling member 3 is electrically connected to a housing of the power conversion device 1a, the circuit board 2, and the like, and thus connected to a ground (GND) potential.

A base 31 of the cooling member 3 has a flat plate shape. At least one protrusion 33 is provided on a front surface 311 (a surface on the Z +side in the drawing) of the base 31. FIG. 1 exemplifies two protrusions 33. The protrusion 33 extends in the Z +direction from the front surface 311 of the base 31. The protrusion 33 is provided to connect the integrally-molded coil 5a to the cooling member 3. As an example, the protrusion 33 has a hole (not illustrated) provided with a screw groove to be fitted with a screw or bolt inserted from the Z +side. An enlarged portion 35 is provided on a back surface 312 (a surface on the Z −side in the drawing) of the base 31. The enlarged portion 35 forms an enlarged heat transfer surface of the heat sink. Note that the enlarged portion 35 is not limited to a rectangular fin, and may have another shape such as a pin fin.

Note that as the cooling member 3, instead of the heat sink or in addition to the heat sink, various heat dissipation mechanisms such as a thermal diffusion plate, a heat dissipation sheet, a heat dissipation gap filler, and a heat pipe can be appropriately used.

Note that the cooling member 3 may be attached to the housing of the power conversion device 1a. The cooling member 3 attached to the housing of the power conversion device 1a may be shared among a plurality of electronic components including the integrally-molded coil 5a. In these cases, the integrally-molded coil 5a may be thermally and electrically connected directly to the housing of the power conversion device 1a by a connecting portion 53.

The integrally-molded coil 5a is an example of a magnetic component of the power conversion device 1a. As illustrated in FIGS. 1 to 4, the integrally-molded coil 5a includes a resin portion 50 and the coil portion 55. The integrally-molded coil 5a is formed by insert molding in which resin constituting the resin portion 50 is injection molded in a state where the coil portion 55 is disposed as an insert. Note that the integrally-molded coil 5a may be formed by providing the resin portion 50 around the coil portion 55 by molding other than injection molding. For example, the integrally-molded coil 5a may be formed by extrusion molding in which resin is extruded around the coil portion 55. For example, the integrally-molded coil 5a may be formed by vacuum molding in which a resin sheet disposed around the coil portion 55 is pressure-bonded to the coil portion 55 by pressurization. As described above, the resin portion 50 and the coil portion 55 are integrally formed in the integrally-molded coil 5a.

The resin portion 50 is formed of a resin material that can be used for insert molding. The resin material forming the resin portion 50 is, for example, a thermosetting resin material such as a phenol resin, but the resin portion 50 may be formed of another resin material. As another resin material, for example, a resin material having heat resistance and thermal conductivity with respect to heat generation of the coil portion 55 and having electrical insulation by which the coil portion 55 and the cooling member 3 can be insulated can be appropriately used.

A main body portion 51 of the resin portion 50 is a member that encloses a coil main body 551. FIGS. 1 to 4 exemplify the main body portion 51 having a columnar shape formed along the shape of the coil main body 551 having a ring shape.

At least one connecting portion 53 is provided on a side surface 513 (a surface parallel to the Z axis in the drawing) of the main body portion 51. FIGS. 1 to 4 exemplify two connecting portions 53. The connecting portion 53 extends outward from the side surface 513 of the main body portion 51 in the radial direction of the main body portion 51.

The connecting portion 53 is provided to connect the cooling member 3 to the integrally-molded coil 5a. As an example, the connecting portion 53 has a hole 534 provided to spatially connect, that is, penetrate between a front surface 531 (a surface on the Z +side in the drawing) and a back surface 532 (a surface on the Z-side in the drawing). A bush 56 is inserted into the hole 534. The bush 56 has, for example, a cylindrical shape. A hole 561 of the bush 56 is slightly larger than a shaft diameter of the screw or bolt inserted into the hole 534 of the connecting portion 53 from the Z +side and fitted into the hole of the protrusion 33 of the cooling member 3. The bush 56 is a component with which a gap between the screw or bolt and the hole 534 of the connecting portion 53 is filled.

Note that the shape of the main body portion 51 may be another shape according to the shape of the coil main body 551, or may not be a shape along the shape of the coil main body 551.

Note that FIGS. 1 to 4 exemplify the connecting portion 53 of the resin portion 50 in which a contact surface with the front surface 311 of the base 31 of the cooling member 3 is parallel to the X-Y plane, but the connecting portion 53 is not limited thereto. The connecting portion 53 may have, for example, an L shape extending in the Z direction from the front surface 531 or the back surface 532, and the contact surface with the front surface 311 of the base 31 of the cooling member 3 may not be parallel to the X-Y plane such that the contact surface is parallel to the Z direction.

The coil main body 551 of the coil portion 55 is covered with the resin portion 50, for example, as in the case of potting. The coil main body 551 is, for example, a filter coil such as a toroidal coil, but may be another coil. The coil portion 55 is provided with one or more pairs of leads 552, 553. FIGS. 1 and 2 exemplify any pair of leads among the one or more pairs of leads 552, 553. That is, at least a pair of leads may be provided in the coil portion 55, another lead (not illustrated) may be provided, or a plurality of three or more leads may be provided. One end of each of the one or more pairs of leads 552, 553 is electrically connected to the coil main body 551 inside the resin portion 50. That is, the one or more pairs of leads 552, 553 are electrically connected via the coil main body 551. The other end of each of the one or more pairs of leads 552, 553 extends to the outside of the resin portion 50. In other words, the one or more pairs of leads 552, 553 are an example of one or more pairs of leads each extending from the coil main body 551 to the outside of the resin portion 50.

In the power conversion device 1a, the integrally-molded coil 5a is thermally and electrically connected to the cooling member 3. Specifically, a back surface 512 (a surface on the Z-side in the drawing) of the main body portion 51 of the resin portion 50 and the front surface 311 of the base 31 of the cooling member 3 are thermally and electrically connected by contact therebetween. In addition, the back surface 532 of the connecting portion 53 of the resin portion 50 and the protrusion 33 of the cooling member 3 are thermally and electrically connected by contact therebetween. In other words, the connecting portion 53 of the resin portion 50 extends from the main body portion 51 and is thermally and electrically connected to the cooling member 3. In addition, the connecting portion 53 of the resin portion 50 is connected to the ground (GND) potential via the cooling member 3.

As an example, the connecting portion 53 of the resin portion 50 and the protrusion 33 of the cooling member 3 are fastened to each other by the screw or bolt inserted into the hole 534 of the connecting portion 53 of the resin portion 50 from the Z +side.

Note that the back surface 532 of the connecting portion 53 of the resin portion 50 and the protrusion 33 of the cooling member 3 may be electrically and thermally connected via the bush 56.

Note that the connecting portion 53 of the resin portion 50 and the protrusion 33 of the cooling member 3 are not limited to joining by a screw or a bolt, and may be joined by an adhesive having thermal conductivity and electrical conductivity such as a heat dissipation bond. Similarly, the back surface 512 of the main body portion 51 of the resin portion 50 and the front surface 311 of the base 31 of the cooling member 3 may be joined by an adhesive having thermal conductivity and electrical conductivity such as a heat dissipation bond. In addition, when the back surface 512 of the main body portion 51 of the resin portion 50 and the front surface 311 of the base 31 of the cooling member 3 are joined, the connecting portion 53 of the resin portion 50 may not be provided.

In the power conversion device 1a, the integrally-molded coil 5a is electrically connected to the circuit board 2. Specifically, the one or more pairs of leads 552, 553 of the coil portion 55 protruding from the main body portion 51 of the resin portion 50 are electrically connected to a circuit pattern (not illustrated) or the like provided on the circuit board 2. That is, the coil main body 551 of the coil portion 55 receives power supply from the circuit board 2 via the one or more pairs of leads 552, 553. For example, the coil main body 551 as a filter coil removes a high-frequency component of a current flowing through a power line of the circuit board 2.

As an example, the one or more pairs of leads 552, 553 penetrate from a back surface 202 (a surface on the Z −side in the drawing) to a front surface 201 (a surface on the Z +side in the drawing) of the circuit board 2, and are electrically connected to a circuit pattern such as a solder land provided on the front surface 201 of the circuit board 2 by, for example, solder bonding.

In the power conversion device 1a configured as described above, an outer surface of the resin portion 50 of the integrally-molded coil 5a is applied with a surface treatment for imparting electrical conductivity (conductivity). In the present embodiment, a case where a coating having electrical conductivity is applied as the surface treatment will be exemplified. Note that the surface treatment on the outer surface of the resin portion 50 may be another coating treatment such as a metal plating treatment.

Specifically, in the main body portion 51, the coating having electrical conductivity is applied to each of a region of a front surface 511 (a surface on the Z +side in the drawing) excluding a contact portion with the one or more pairs of leads 552, 553, the back surface 512, and the side surface 513. That is, the coating applied to the outer surface of the main body portion 51 is not electrically connected to, that is, insulated from, the one or more pairs of leads 552, 553. In addition, in the connecting portion 53, the coating having electrical conductivity is applied to each of the front surface 531, the back surface 532, the side surface 513, and an inner peripheral surface of the hole 534.

Note that when the bush 56 is formed of a material having no conductivity such as resin, a metal coating may also be applied to an outer surface of the bush 56.

As an example, the coating having electrical conductivity may be a metal coating. For example, the metal coating may be applied by applying or painting a coating material containing a conductive material such as metal having electrical conductivity to an outer surface of the integrally-molded coil 5a after insert molding.

As an example, the metal coating may be applied by further disposing a conductive film such as a metal foil in a state where the coil portion 55 is disposed as an insert, and by injection molding resin constituting the resin portion 50 between the coil portion 55 and the film. That is, the integrally-molded coil 5a may be formed by decorative molding as insert molding.

As described above, the integrally-molded coil 5a according to the embodiment is formed by integrally forming a filter coil with a resin member using an integral molding technique and adding a shielding function by a metal coating to an outer wall of an insert-molded article. That is, the integrally-molded coil 5a according to the embodiment has a coil structure formed by combining a coil integral molding technique and shielding by a metal coating.

Conventionally, since a filter coil of an in-vehicle charger has large heat generation and radiation noise, it has been necessary to provide electromagnetic shielding while cooling and insulating the filter coil. Under such circumstances, by integrally molding the coil portion 55 with the resin portion 50, a heat dissipation structure better than potting can be realized. Furthermore, by applying a metal coating to the outer surface of the molded article, an electrostatic shielding (electrostatic shielding) structure can be realized.

Therefore, according to the coil-integral molding structure having a shielding function of the present disclosure, since the manufacturing can be simplified by integral molding, and the heat dissipation function and the shielding function can be added by a metal coating, a large-scale structure for cooling and electromagnetic shielding is unnecessary, and the internal structure can be simplified. That is, according to the above configuration, cooling and electromagnetic shielding can be easily realized.

For example, it is possible to eliminate the need for a conventional cooling structure for dissipating heat generated in a coil to a housing by a gap filler, a heat dissipation sheet, potting, or the like, or forcibly cooling the housing with water. In addition, for example, by reducing a large-scale shielding structure and a heat dissipation structure using an indirect material, it is possible to alleviate restrictions on manufacturing.

Furthermore, the metal coating applied to the integrally-molded coil 5a is electrically connected to the housing via, for example, the cooling member 3. According to this configuration, heat can be dissipated while taking GND of the shielding structure using the metal coating, and thus the number of components can be reduced.

### Second Embodiment

Hereinafter, a second embodiment of the present disclosure will be described with reference to the drawings. Here, differences from the first embodiment will be mainly described, and redundant description will be appropriately omitted.

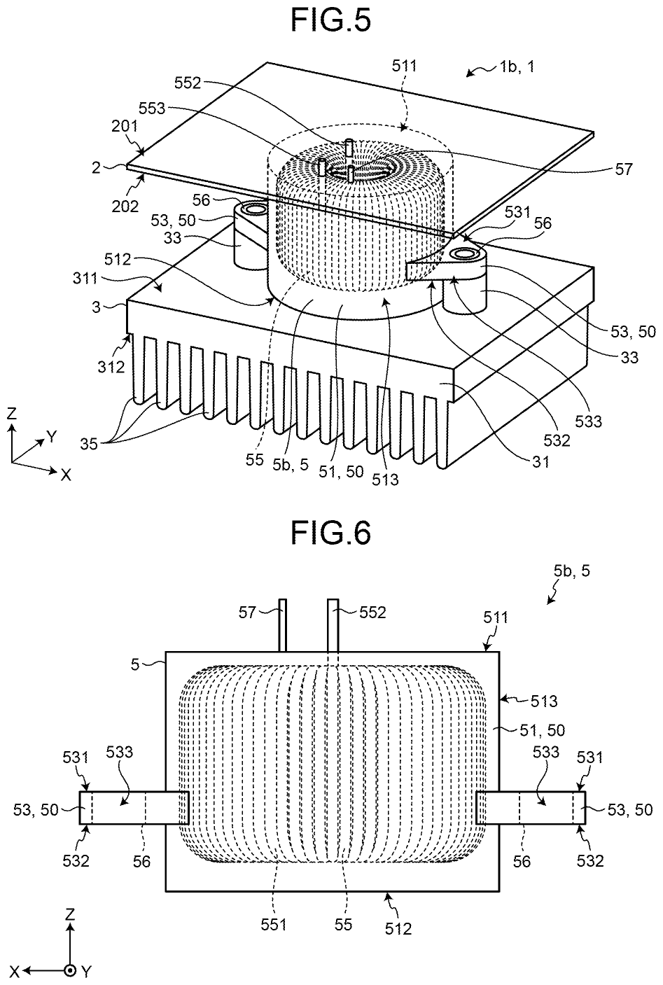

FIG. 5 is a schematic perspective view illustrating an example of a configuration of a power conversion device 1b according to the second embodiment. FIG. 6 is a front view illustrating a schematic configuration of an integrally-molded coil 5b in FIG. 5.

As illustrated in FIGS. 5 and 6, the integrally-molded coil 5b according to the present embodiment further includes a ground (GND) terminal 57. That is, the integrally-molded coil 5b according to the present embodiment has a configuration in which the GND terminal 57 is added to the integrally-molded coil 5a according to the first embodiment.

As illustrated in FIG. 5, one end of the GND terminal 57 is electrically connected to the main body portion 51 of the resin portion 50, and the other end is electrically connected to a node at the GND potential in a circuit pattern (not illustrated) or the like provided on the circuit board 2. As illustrated in FIG. 6, the GND terminal 57 is provided on the front surface 511 of the main body portion 51 of the resin portion 50. The GND terminal 57 is electrically connected to the metal coating provided on the outer surface of the resin portion 50. In other words, the GND terminal 57 is a terminal that extends from the outer surface of the resin portion 50 and is electrically connected to each of the metal coating and the circuit board 2. That is, the GND terminal 57 is connected to the GND potential via the circuit board 2. On the other hand, the GND terminal 57 is not in contact with and is insulated from the coil portion 55.

Note that without being limited to the front surface 511 of the main body portion 51 of the resin portion 50, the GND terminal 57 may be provided on the side surface 513. In addition, the GND terminal 57 may be provided on the cooling member 3, and the potential of the metal coating of the integrally-molded coil 5b may be dropped to the GND potential via the cooling member 3.

Note that in the power conversion device 1b according to the present embodiment, the cooling member 3 may not have electrical conductivity. In addition, the cooling member 3 may not be electrically connected to the housing of the power conversion device 1b or the circuit board 2, and may not be connected to the GND potential without the GND terminal 57. In other words, the connecting portion 53 of the resin portion 50 extends from the main body portion 51 and is at least thermally connected to the cooling member 3.

Note that the integrally-molded coil 5b may be formed by insert molding in which resin constituting the resin portion 50 is injection molded in a state where the GND terminal is disposed as an insert in addition to the coil portion 55.

As described above, the integrally-molded coil 5b and the cooling member 3 may not be electrically connected, and the potential of the metal coating may be dropped to the node at the GND potential in the circuit board 2. Even with this configuration, effects similar to those of the above-described embodiment can be obtained.

In addition, for example, in a case where it is not necessary to attach the integrally-molded coil 5b to the housing of the power conversion device 1b and cool the integrally-molded coil 5b, such as a case where the integrally-molded coil 5b can be sufficiently cooled by the cooling member 3, the integrally-molded coil 5b can be mounted on the circuit board 2 as it is. According to the configuration in which the integrally-molded coil 5b is directly attached to the circuit board 2, the configuration of the power conversion device 1b can be further simplified.

### Third Embodiment

Hereinafter, a third embodiment of the present disclosure will be described with reference to the drawings. Here, differences from the second embodiment will be mainly described, and redundant description will be appropriately omitted.

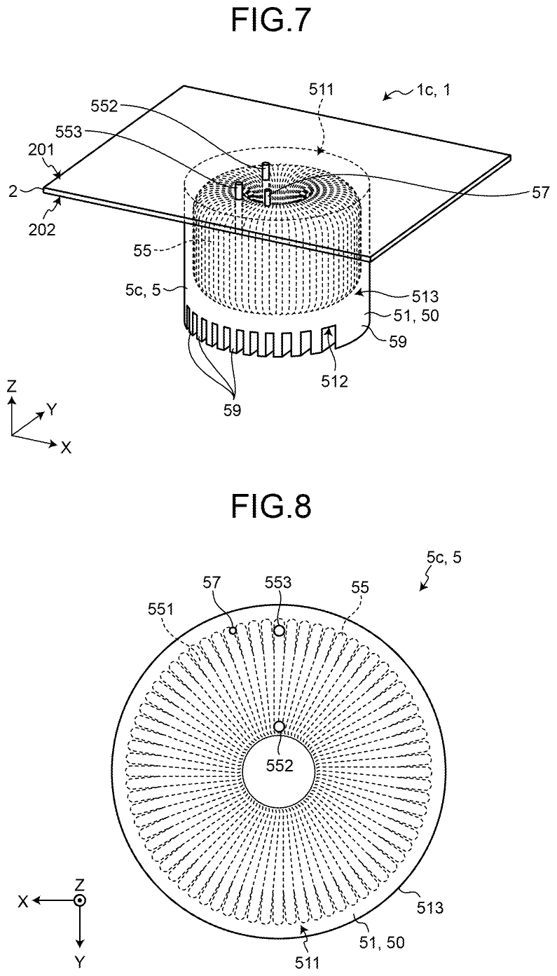

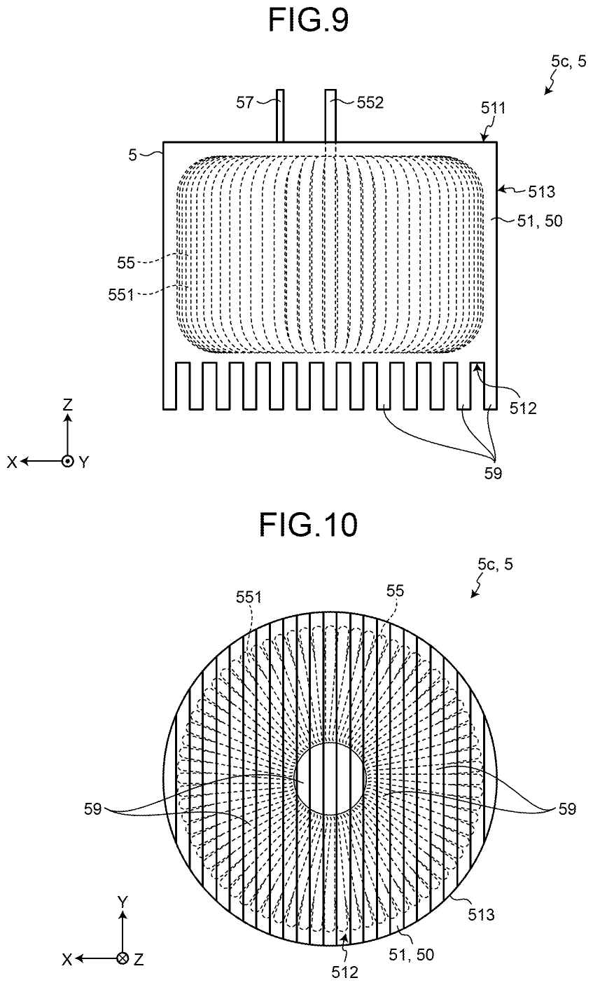

FIG. 7 is a schematic perspective view illustrating an example of a configuration of a power conversion device 1c according to the third embodiment. FIG. 8 is a plan view illustrating a schematic configuration of an integrally-molded coil 5c in FIG. 7. FIG. 9 is a front view illustrating the schematic configuration of the integrally-molded coil 5c in FIG. 7. FIG. 10 is a bottom view illustrating the schematic configuration of the integrally-molded coil 5c in FIG. 7.

As illustrated in FIG. 7, the power conversion device 1c according to the present embodiment does not include the cooling member 3. In addition, the resin portion 50 of the integrally-molded coil 5c according to the present embodiment is not provided with the connecting portion 53. On the other hand, an enlarged portion 59 is provided on the back surface 512 of the main body portion 51 of the resin portion 50.

The enlarged portion 59 extends from the main body portion 51 to form an enlarged heat transfer surface of the heat sink. FIGS. 7 to 10 exemplify the enlarged portion 59 of the resin portion 50 formed as a fin row whose length in the Y direction changes along the X direction according to the columnar shape of the main body portion 51, that is, the circular shape of the back surface 512.

Note that a metal coating is applied to an outer surface of the enlarged portion 59, that is, each of the enlarged heat transfer surface and the back surface 512 of the main body portion 51 of the resin portion 50.

Note that the shape of the enlarged portion 59 of the resin portion 50 may not be a shape along the shape of the main body portion 51. For example, the enlarged portion 59 may be larger than the back surface 512 of the main body portion 51 in the X-Y plane, and may be a rectangular fin.

Note that the enlarged portion 59 of the resin portion 50 may be provided on the front surface 511 or the side surface 513 instead of or in addition to the back surface 512 of the main body portion 51.

As described above, a part of the resin portion 50 of the integrally-molded coil 5c may be formed in the form of a heat sink by insert molding. According to this configuration, the configuration of the power conversion device 1c can be further simplified.

According to at least one embodiment described above, cooling and electromagnetic shielding can be easily realized.

According to the present disclosure, cooling and electromagnetic shielding can be easily realized.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### (Supplementary Note)

The following technique is disclosed by the above description of the embodiments.

(1) An integrally-molded coil includes:
a coil portion; and
a resin portion formed by molding a resin material having electrical insulation and thermal conductivity using the coil portion as an insert, in which
the coil portion includes a coil main body and one or more pairs of leads each extending from the coil main body to an outside of the resin portion, and an outer surface of the resin portion is applied with a surface treatment for imparting electrical conductivity, and is insulated from the one or more pairs of leads.

(2) In the integrally-molded coil according to (1),
the resin portion includes a main body portion enclosing the coil main body, and a connecting portion extending from the main body portion and thermally and electrically connected to a cooling member, and
the connecting portion is connected to a ground potential via the cooling member.

(3) The integrally-molded coil according to (1) or (2), further includes a terminal extending from the outer surface of the resin portion and electrically connected to each of the outer surface applied with the surface treatment and a circuit board, in which
the terminal is connected to a ground potential via the circuit board.

(4) In the integrally-molded coil according to (3), the resin portion includes a main body portion enclosing the coil main body, and a connecting portion extending from the main body portion and thermally connected to a cooling member.

(5) In the integrally-molded coil according to (3), the resin portion includes a main body portion enclosing the coil main body, and an enlarged portion extending from the main body portion to form an enlarged heat transfer surface.

(6) A power conversion device includes:
the integrally-molded coil according to any one of (1) to (5) ; and
a circuit board electrically connected to the one or more pairs of leads and supplying power to the coil main body via the one or more pairs of leads.

What is claimed is:

1. An integrally-molded coil comprising:
a coil portion; and
a resin portion formed by molding a resin material having electrical insulation and thermal conductivity using the coil portion as an insert, wherein
the coil portion includes a coil main body and one or more pairs of leads each extending from the coil main body to an outside of the resin portion, and
an outer surface of the resin portion is applied with a surface treatment for imparting electrical conductivity, and is insulated from the one or more pairs of leads.

2. The integrally-molded coil according to claim 1, wherein
the resin portion includes a main body portion enclosing the coil main body, and a connecting portion extending from the main body portion and thermally and electrically connected to a cooling member, and
the connecting portion is connected to a ground potential via the cooling member.

3. The integrally-molded coil according to claim 1, further comprising a terminal extending from the outer surface of the resin portion and electrically connected to each of the outer surface applied with the surface treatment and a circuit board, wherein
the terminal is connected to a ground potential via the circuit board.

4. The integrally-molded coil according to claim 2, further comprising a terminal extending from the outer surface of the resin portion and electrically connected to each of the outer surface applied with the surface treatment and a circuit board, wherein
the terminal is connected to a ground potential via the circuit board.

5. The integrally-molded coil according to claim 3, wherein
the resin portion includes a main body portion enclosing the coil main body, and a connecting portion extending from the main body portion and thermally connected to a cooling member.

6. The integrally-molded coil according to claim 4, wherein
the resin portion includes a main body portion enclosing the coil main body, and a connecting portion extending from the main body portion and thermally connected to a cooling member.

7. The integrally-molded coil according to claim 3, wherein
the resin portion includes a main body portion enclosing the coil main body, and an enlarged portion extending from the main body portion to form an enlarged heat transfer surface.

8. The integrally-molded coil according to claim 4, wherein
the resin portion includes a main body portion enclosing the coil main body, and an enlarged portion extending from the main body portion to form an enlarged heat transfer surface.

9. A power conversion device comprising:
an integrally-molded coil; and
a circuit board,
the integrally-molded coil comprising:
a coil portion; and
a resin portion formed by molding a resin material having electrical insulation and thermal conductivity using the coil portion as an insert, wherein
the coil portion includes a coil main body and one or more pairs of leads each extending from the coil main body to an outside of the resin portion,
an outer surface of the resin portion is applied with a surface treatment for imparting electrical conductivity, and is insulated from the one or more pairs of leads, and
the circuit board is electrically connected to the one or more pairs of leads and supplies power to the coil main body via the one or more pairs of leads.

10. The power conversion device according to claim 9, wherein
the resin portion includes a main body portion enclosing the coil main body, and a connecting portion extending from the main body portion and thermally and electrically connected to a cooling member, and
the connecting portion is connected to a ground potential via the cooling member.

11. The power conversion device according to claim 9, wherein
the integrally-molded coil further includes a terminal extending from the outer surface of the resin portion and electrically connected to each of the outer surface applied with the surface treatment and the circuit board, and
the terminal is connected to a ground potential via the circuit board.

12. The power conversion device according to claim 10, wherein
the integrally-molded coil further includes a terminal extending from the outer surface of the resin portion and electrically connected to each of the outer surface applied with the surface treatment and the circuit board, wherein
the terminal is connected to a ground potential via the circuit board.

13. The power conversion device according to claim 11, wherein
the resin portion includes a main body portion enclosing the coil main body, and a connecting portion extending from the main body portion and thermally connected to a cooling member.

14. The power conversion device according to claim 12, wherein
the resin portion includes a main body portion enclosing the coil main body, and a connecting portion extending from the main body portion and thermally connected to a cooling member.

15. The power conversion device according to claim 11, wherein
the resin portion includes a main body portion enclosing the coil main body, and an enlarged portion extending from the main body portion to form an enlarged heat transfer surface.

16. The power conversion device according to claim 12, wherein
the resin portion includes a main body portion enclosing the coil main body, and an enlarged portion extending from the main body portion to form an enlarged heat transfer surface.
